(19) United States
(12) Patent Application Publication
(10) Pub. No.: US 2009/0056965 A1
(43) Pub. Date: Mar. 5, 2009

(54) Vibrating hand-held power tool with a locking switch for the motor switch

(75) Inventor: Franz Moessnang, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/229,044

(22) Filed: Aug. 18, 2008

(30) Foreign Application Priority Data
Aug. 29, 2007 (DE) 10 2007 000 470.4

(51) Int. Cl. B25F 5/00

(52) U.S. Cl. 173/18

(57) ABSTRACT

A rotary-percussion hand-held power tool capable of applying blows along a percussion axis (A) includes a percussion mechanism assembly (2) with a mode selection switch (3), a guide handle (4) vibrationally decoupled from the percussion mechanism assembly (2) and with a motor switch (5) for turning a power tool motor on and off, a locking switch (7) for locking the motor switch and displaceable in a switching region (X), and a switching linkage (9) displaceable by the mode selection switch (3) and having a stop (10) displaceable during a drilling operational mode into the switching region (X) of the locking switch (7), with the switching linkage (9) having two legs (16a, 16b) extending at an angle to each other, and with one of the legs (16a), which is more stiff and forms the stop (10), being pivotally supported on the percussion mechanism assembly (2), and another of the legs (16b), which extends axially and is flexural, being connected with the mode selection switch (3).

### BACKGROUND OF THE INVENTION

1. Field of the Invention

The present invention relates to a rotary-percussion hand-held power tool such as a combination hammer with a locking switch for the motor switch for locking the motor switch during a chiseling operation.

2. Description of the Prior Art

In the hand-held power tools of the type discussed above which apply blows along a percussion axis, the guide handle of the power tool is vibrationally decoupled from the tool percussion mechanism assembly. During the pure chiseling operation, usually, the motor on-off switch is locked in its on-position by the locking switch. However, the motor switch is not locked by the locking switch in a further drilling operation mode. Under the term “percussion mechanism assembly,” both motor/percussion mechanism assembly or combined motor/gear unit assembly are understood.

German Publication DE 100 34 768 discloses a hand-held power tool in which the guide handle is vibrationally decoupled from the percussion mechanism assembly. The locking switch for the motor switch is formed as a catch bracket pivotally supported at a proper handling in the lower bracket of the guide handle at several points. The catch bracket is connected with the rotary mode selection switch of the percussion mechanism assembly. This solution is technologically expensive and requires availability of free space in the handle lower bracket.

German Publication DE 199 37 767 discloses a hand-held power tool that vibrates along a percussion axis and has a motor switch that is provided in the guide handle. On its upper handle bracket (at a proper handling), there is arranged a locking switch that locks the motor switch in the completely actuated position of the motor switch. A displaceable stiff switching bar, which controls the locking switch and is connected with the rotary mode selection switch of the percussion mechanism assembly by an eccentric disc, insures that locking of the motor switch is possible exclusively in the chiseling operational mode but not during a further drilling operational mode.

An object of the present invention is to provide a hand-held power tool with a technologically simple control of the locking switch for the motor switch arranged in a vibrationally decoupled guide handle.

Another object of the present invention is to provide a hand-held power tool with a space-saving design of the switching linkage or bar.

### SUMMARY OF THE INVENTION

These and other objects of the present invention which will become apparent hereinafter, are achieved by providing a rotary-percussion hand-held power tool capable of applying blows along a percussion axis and including a percussion mechanism assembly, a mode selection switch provided in the percussion mechanism assembly, a guide handle vibrationally decoupled from the percussion mechanism assembly, a motor switch provided in the guide handle for turning a power tool motor on and off, a locking switch associated with the motor switch for locking same and displaceable in a switching region, and a switching linkage displaceable by the mode selection switch and having a stop displaceable during a drilling operational mode into the switching region of the locking switch. The switching linkage has two legs extending at an angle to each other, with one of the legs, which is flexurally stiff, forming the stop and being pivotally supported on the percussion mechanism assembly at a pivot point, and with another of the legs which extends axially and is flexural, being connected with the mode selection switch.

By controlling the locking function with a stop not connected with the locking switch, a fatigue-free and technologically simple locking of the motor switch is carried out even with a guide handle that is vibrationally decoupled from the percussion mechanism assembly. Because the switching linkage is pivotally supported at a pivot point, only the leg that forms the stop should be formed sufficiently rigid. The other leg should (must) be deformable, which, saves space and material. In addition, with a lever articulation, the displacement of the stop relative to the eccentric stroke becomes possible.

Advantageously, the flexural leg forms an integral hinge in the vicinity of the corner formed by the two legs. Thereby, with an axial displacement of the flexural leg, the angle between the two legs is elastically changed and, thus, without any damage of the linkage.

Advantageously, the flexural leg forms also an integral hinge in vicinity of its connection with the mode selection switch. Thereby, upon a pivotal movement of the flexurally stiff leg, the produced angular change of the flexural leg takes place elastically and, thus, damage-free.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a partial perspective view of a hand-held power tool according to the present invention;

FIG. 2 a schematic view of the mode selection switch-stop switch assembly in the chisel operating mode (solid lines), with the drilling mode shown with dash lines; and

FIG. 3 a perspective view of the switching linkage of the power tool shown in FIG. 1.

### DETAILED DESCRIPTION OF THE PREFERRED EMBODIMENTS

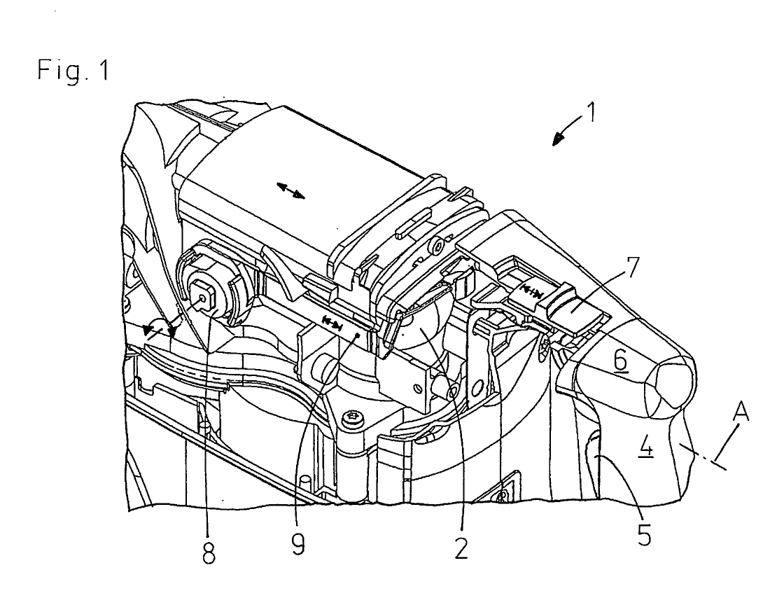

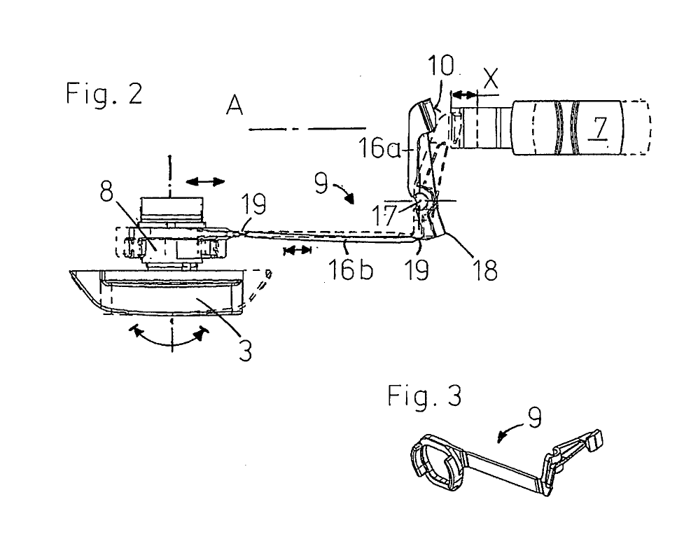

A rotary-percussion hand-held power tool 1, which applies blows along a percussion axis A, is formed as a combination hammer, and is shown in FIG. 1, includes a percussion mechanism assembly 2 with a rotary mode selection switch 3 (FIG. 2) displaceable between a rotary-percussion drilling operational mode and only percussion chiseling operational mode, and a vibration-decoupled guide handle 4. A motor on-off switch 5 for switching the motor operation on and off is provided in the guide handle 4. For locking the motor switch 5 in its on position, there is provided, on the upper surface of the upper bracket 6 of the handle 4, a locking switch 7 in form of an axially longitudinally displaceable slide.

As shown in FIG. 2, with the mode selection switch 3 being displaced into its chiseling operational mode position, a switching linkage 9 is axially displaced by an eccentric disc 8 toward the percussion mechanism 3, whereby a stop 10, which is associated with the switching linkage 9, does not project in the switching region X of the locking switch 7. As a result, the locking switch 7 can be displaced far enough in the direction of the percussion mechanism 2 for locking the motor switch 5 (FIG. 1). Contrary to this, with the mode selection switch 3 being displaced into its drilling operational mode position (shown with dash lines), the switching linkage 9 is axially displaced toward the handle 4. Thereby the stop 10 projects into the switching region X of the locking switch 7 and as a result, the locking switch 7 cannot be displaced sufficiently far in the direction of the percussion mechanism assembly 2 for locking the motor switch 5 (FIG. 1). The switching linkage 9 is formed with two legs 16a and 16b extending at angle to each other, with the flexurally stiff leg 16a (recognizably by a transverse web), which forms the stop 10, being pivotally supported on the percussion mechanism assembly 2 at a pivot point 17 (FIG. 2) outside of the center of the leg 16a. The other, axially extending leg 16b, which is connected with the mode selection switch 3, is flexural (as recognized by a transverse deformation) and is provided with an integral hinge 19 in the vicinity of its connection with the mode selection switch 3 and in the vicinity of the corner 18 formed by the legs 16a and 16b.

The switching linkage 9, which is shown in FIG. 3, is formed of a plastic material as a one-piece injection-molded component.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A rotary-percussion hand-held power tool capable of applying blows along a percussion axis (A), the power tool comprising a percussion mechanism assembly (2); a mode selection switch (3) provided in the percussion mechanism assembly (2); a guide handle (4) vibrationally decoupled from the percussion mechanism assembly (2); a motor switch (5) provided in the guide handle (4) for turning a power tool motor on and off; a locking switch (7) associated with the motor switch (5) for locking same and displaceable in a switching region (X); and a switching linkage (9) displaceable by the mode selection switch (3) and having a stop (10) displaceable during a drilling operational mode into the switching region (X) of the locking switch (7), the switching linkage (9) having two legs (16a, 16b) extending at an angle to each other, one of the legs (16a), which is flexurally stiff and forms the stop (10), being pivotally supported on the percussion mechanism assembly (2) at a pivot point (17), and another of the legs (16b), which extends axially and is flexural, being connected with the mode selection switch (3).

2. A hand-held power tool according to claim 1, wherein the flexural leg (16b) forms an integral hinge (19) in vicinity of a corner (18) formed by the two legs (16a, 16b).

3. A hand-held power tool according to claim 2, wherein the flexural leg (16b) forms an integral hinge (19) in vicinity of its connection with the mode selection switch (3).
